(19) United States
(12) Patent Application Publication
(10) Pub. No.: US 2018/0081780 A1
(43) Pub. Date: Mar. 22, 2018

(54) TRACE-INFORMATION MANAGEMENT SYSTEM, TRACE-INFORMATION MANAGEMENT METHOD, AND TRACE-INFORMATION MANAGEMENT PROGRAM PRODUCT

(71) Applicant: Kabushiki Kaisha Toshiba, Minato-ku (JP)

(72) Inventors: Nobuaki Tojo, Yokohama (JP); Hidenori Matsuzaki, Fuchu (JP); Akira Kuroda, Yokohama (JP); Mayuko Koezuka, Ota (JP); Xinxiao Li, Yokohama (JP)

(73) Assignee: Kabushiki Kaisha Toshiba, Minato-ku (JP)

(21) Appl. No.: 15/452,275

(22) Filed: Mar. 7, 2017

(30) Foreign Application Priority Data
Sep. 21, 2016 (JP) 2016-184437
Feb. 23, 2017 (JP) 2017-032309

(51) Int. Cl. G06F 11/34; G06F 11/30

(52) U.S. Cl. CPC G06F 11/3495; G06F 11/3006

(57) ABSTRACT

A trace-information management system includes a processor configured to acquire trace information indicating transition of a state of an event that occurs in chronological order, acquire index information indicating a correspondence relation between the event and the state at index timings set so as to have a predetermined time interval therebetween on a time axis of the trace information, set a start time point, and generate initial state information indicating the state at the start time point, based on the trace information and the index information.

### CROSS-REFERENCE TO RELATED APPLICATIONS

This application is based upon and claims the benefit of priority from Japanese Patent Application No. 2016-184437, filed on Sep. 21, 2016 and Japanese Patent Application No. 2017-032309, filed on Feb. 23, 2017; the entire contents of which are incorporated herein by reference.

### FIELD

Embodiments described herein relate generally to a trace-information management system, a trace-information management method, and a trace-information management program product.

### BACKGROUND

Trace information that is an aggregation of information in which a time point and an attribute value are linked with each other obtained by executing a program is used for various purposes. For example, the trace information indicating state transition of an event generated by executing a program is used, for example, for visualizing an execution status of a program, and for dynamic analysis of program performance.

As a data format of the trace information, there is a format in which information in a unit of function is stored in an RDB (relational database), and not only the symbol name of function, start time, and processing time are associated with each other, but also a call relation between functions and an identification number added for each occurrence of a call are associated therewith.

The trace information sometimes has a large amount of data. Therefore, there may be a case where it is required to use only a part of the trace information. For example, there may be a case where processing such as visualization is performed by using only information related to state transition of an event occurred in a predetermined time range of the entire trace information.

A database using the RDB is suitable for recording the state transition of a trace in chronological order and extracting data within a predetermined time range. However, although data corresponding to a timing when the state transition has occurred (a timing at which when an event (a function) has started or ended) is included in a conventional database, but data indicating a state of the event at timings other than the timing when the state transition has occurred is not included therein. Therefore, even if a record within the predetermined time range is simply extracted from the database, the state of the event at the start time point in the predetermined time range may not be able to be ascertained. Therefore, in order to ascertain the state of the event within the predetermined time range, there may be a case where the trace information needs to be read from the beginning.

### BRIEF DESCRIPTION OF THE DRAWINGS

FIG. 1 is a diagram exemplifying a hardware configuration of a trace-information management system according to a first embodiment;

FIG. 2 is a diagram exemplifying an internal configuration of an information processing terminal and a server according to the first embodiment;

FIG. 3 is a diagram exemplifying a functional configuration of the trace-information management system according to the first embodiment;

FIG. 4 is a diagram exemplifying trace information according to a first example of the first embodiment;

FIG. 5 is a diagram exemplifying index information according to the first example of the first embodiment;

FIG. 6 is a diagram exemplifying initial state information and state transition information according to the first embodiment;

FIG. 7 is a flowchart illustrating an overall processing flow in the trace-information management system according to the first embodiment;

FIG. 8 is a flowchart exemplifying a processing flow at the time of acquiring the index information from the trace information according to the first embodiment;

FIG. 9 is a diagram exemplifying an internal table used at the time of acquiring the index information from the trace information according to the first embodiment;

FIG. 10 is a flowchart illustrating a processing flow at the time of generating the initial state information according to the first embodiment;

FIG. 11 is a flowchart illustrating a processing flow at the time of generating the state transition information according to the first embodiment;

FIG. 12 is a diagram exemplifying trace information according to a second example of the first embodiment;

FIG. 13 is a diagram exemplifying index information according to the second example of the first embodiment;

FIG. 14 is a diagram exemplifying initial state information and state transition information according to the second example of the first embodiment;

FIG. 15 is a diagram exemplifying index information according to a third example of the first embodiment;

FIG. 16 is a diagram exemplifying index information according to a fourth example of the first embodiment;

FIG. 17 is a diagram exemplifying initial state information and state transition information according to the third example of the first embodiment;

FIG. 18 is a diagram exemplifying a process at the time of generating state transition information according to a first example of a second embodiment;

FIG. 19 is a diagram exemplifying a process at the time of generating state transition information according to a second example of the second embodiment; and

FIG. 20 is a diagram exemplifying a display image that visualizes state transition of an event having occurred within a time range, by using the initial state information and the state transition information according to the second example of the second embodiment.

FIG. 21 is a diagram exemplifying a functional configuration of a visualization system according to a third embodiment.

### DETAILED DESCRIPTION

### First Embodiment

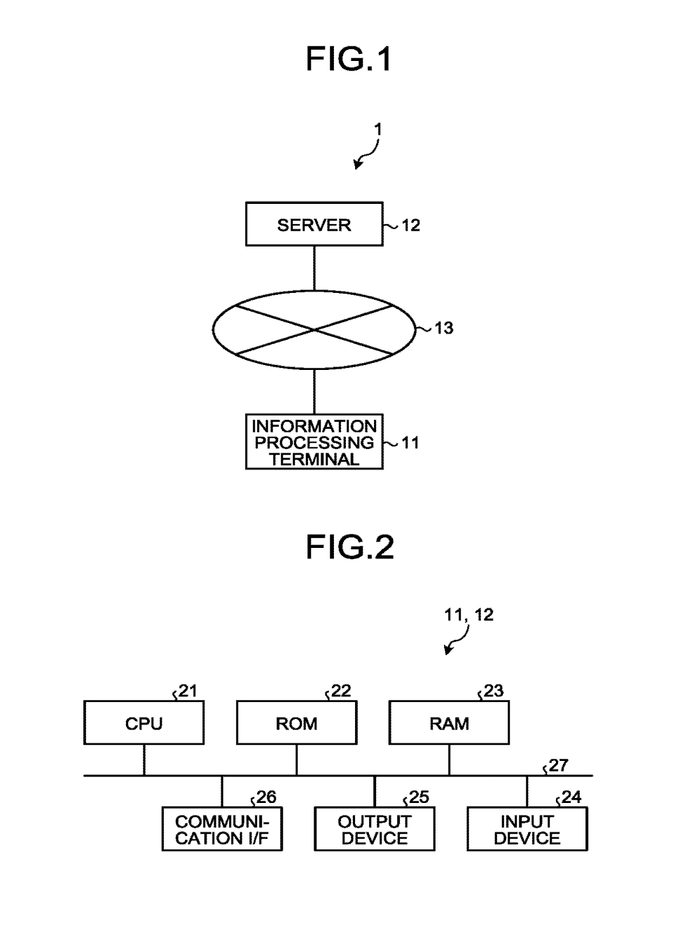

FIG. 1 is a diagram exemplifying a hardware configuration of a trace-information management system 1 according to a first embodiment. The trace-information management system 1 in this example includes an information processing terminal 11, a server 12, and a network 13. The information processing terminal 11 can be a PC (personal computer), a tablet, a smart phone, or the like used by a user. The server 12 can be a server computer or the like operated by an operator of the trace-information management system 1. The information processing terminal 11 and the server 12 are connected via the network 13 such as the Internet or a LAN (Local Area Network). In FIG. 1, one information processing terminal 11 and one server 12 are illustrated. However, both of the information processing terminal 11 and the server 12 or any one thereof may be present in plural.

FIG. 2 is a diagram exemplifying an internal configuration of the information processing terminal 11 and the server 12 according to the first embodiment. The information processing terminal 11 and the server 12 respectively include a CPU (Central Processing Unit) 21, a ROM (Read Only Memory) 22, a RAM (Random Access Memory) 23, an input device 24, an output device 25, a communication I/F (Interface) 26, and a bus 27. The CPU 21 performs predetermined arithmetic processing according to a control program stored in the ROM 22 or the like by using the RAM 23 as a working area. The input device 24 is a device for inputting information from outside, and is, for example, a keyboard, a mouse, or a touch panel. The output device 25 is for outputting information generated therein to outside, and is, for example, a display or a printer. The input device 24 and the output device 25 are normally included in the information processing terminal 11; however, these may not be included in the server 12. The communication I/F 26 is a device that enables transmission and reception of information between an external device and the information processing terminal 11 or the server 12 via the network 13.

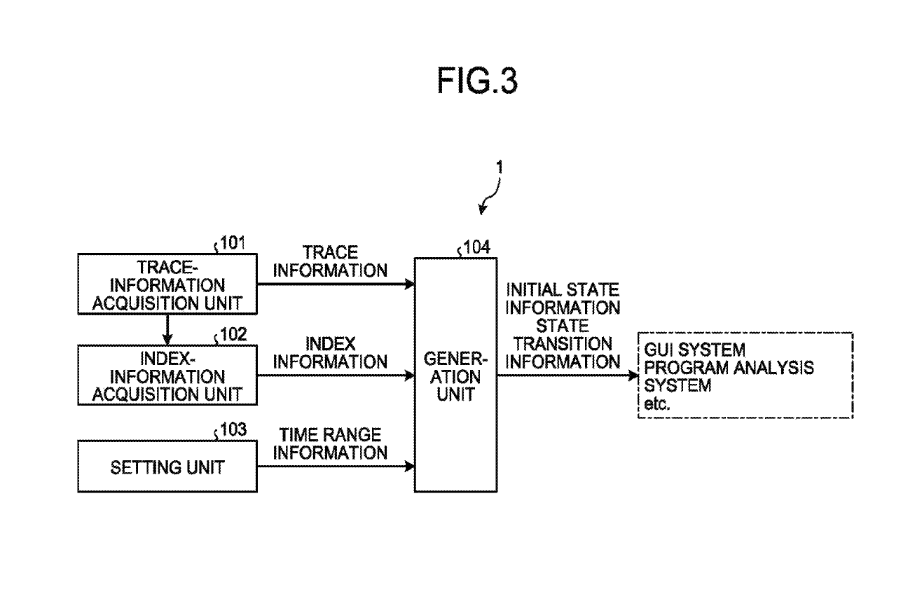

FIG. 3 is a diagram exemplifying a functional configuration of the trace-information management system 1 according to the first embodiment. The trace-information management system 1 includes a trace-information acquisition unit 101 (first acquisition unit), an index-information acquisition unit 102 (second acquisition unit), a setting unit 103, and a generation unit 104.

The trace-information acquisition unit 101 acquires trace information. The trace information is an aggregation of information in which a time point and an attribute value are linked with each other. It is preferable that pieces of information are arranged in order of time point. In the first embodiment, it is described that the trace information indicates a series of state transition events generated by executing a program (a source code) in chronological order. Further, for example, the trace information can be an aggregation of information in which data output from a sensor and a time point are linked with each other, an aggregation of access histories to a Web service, an aggregation of information output from hardware, an aggregation of information output from software, or the like.

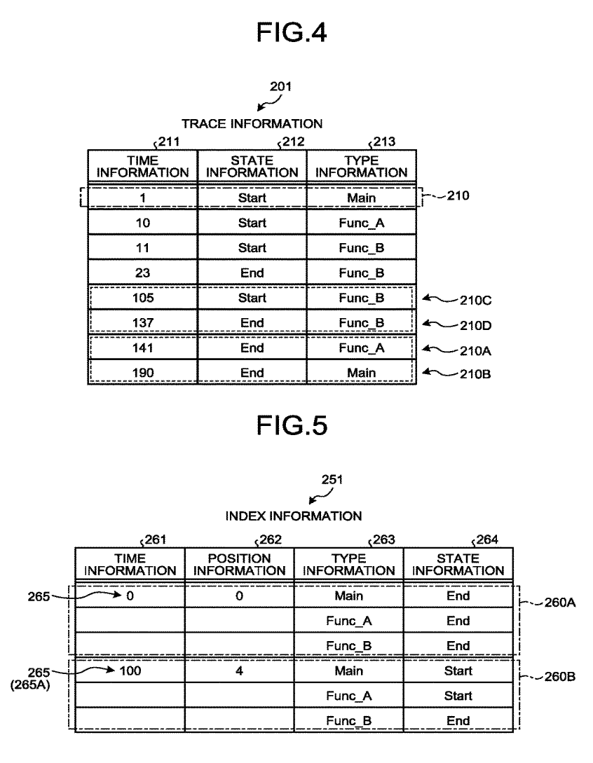

FIG. 4 is a diagram exemplifying trace information 201 according to a first example of the first embodiment. The trace information 201 according to this example includes, as fields, time information 211, state information 212, and type information 213, and is configured by one or more records 210 in which these fields are associated with each other. The type information 213 is information indicating the type of an event (a function symbol name or the like), and has three types of Main, Func_A, and Func_B in this example. The state information 212 is information indicating the state of an event indicated by the type information 213, and has two types of Start and End in this example. Start indicates that an event has shifted from a stopped state to a start state. End indicates that the event has shifted from the start state (an executed state) to the stopped state. The time information 211 is information indicating a timing at which an event indicated by the type information 213 has shifted to a state indicated by the state information 212, and is an elapsed time counted from 0 in this example. The time information 211 is not particularly limited, and can be a time stamp, the number of clocks, or the like other than the elapsed time. The respective records 210 are generated when the state of the event has shifted from End to Start or from Start to End. The data structure described above is only an example, and the structure of the trace information 201 is not limited to the data structure described above.

The index-information acquisition unit 102 acquires index information. The index information is information acquired based on the trace information, and indicating a correspondence relation between the event and the state at a plurality of index timings set so as to have a predetermined time interval therebetween on a time axis of the trace information.

FIG. 5 is a diagram exemplifying index information 251 according to the first example of the first embodiment. The index information 251 according to this example includes, as fields, time information 261, position information 262, type information 263, and state information 264, and is configured by one or more records 260A, 260B, . . . in which these fields are associated with each other. The time information 261 is information indicating index timings (0, 100, 200, . . . in this example) 265 set so as to have a predetermined time interval (100 in this example) therebetween. The time information 211 of the trace information 201 and the time information 261 of the index information 251 are based on a common time axis. The position information 262 is information indicating to which position in the trace information 201 the index timing 265 corresponds. The type information 263 and the state information 264 indicate a correspondence relation between the event and the state at the index timing 265. In this example, it is indicated that the states of all the events of Main, Func_A, and Func_B are End at an index timing 265: 0, and Main and Func_A are Start and Func_B is End at an index timing 265: 100. In one of the records 260A, 260B, . . . , the position information 262, the type information 263, and the state information 264 corresponding to one index timing 265 are associated with each other. The data structure described above is only an example, and the index information 251 is not limited thereto. For example, the time interval described above (an interval between index timings: 100) is not necessarily fixed, and can be an interval with which the number of records included in the index information 251 becomes constant, an interval based on a table specified from outside, or the like.

The trace-information acquisition unit 101 acquires the trace information 201 described above. The index-information acquisition unit 102 acquires the index information 251 described above. The trace-information acquisition unit 101 and the index-information acquisition unit 102 can be configured by using, for example, the control program stored in the CPU 21 or the ROM 22, the RAM 23, or an appropriate logic IC (Integrated Circuit). “Acquisition” here includes reception of data from outside, and generation of data therein. That is, the trace information 201 and the index information 251 can be generated by a system other than the trace-information management system 1, or can be generated in the trace-information management system 1. A generation method of the trace information 201 and the index information 251 is not particularly limited, and it suffices that the trace information 201 and the index information 251 are appropriately generated by using a known or new technique. An acquisition method of the index information 251 is described in detail later.

The setting unit 103 sets a predetermined time range on the time axis of the time information 211 in the trace information 201. For example, when the time range is set to 140 to 190 in the trace information 201 illustrated in FIG. 4, a record 210A indicating that the state of Func_A has shifted to END when the elapsed time is 141 and a record 210B indicating that the state of Main has shifted to END when the elapsed time is 190 are the data included in the corresponding time range. The setting unit 103 can set a specific type from the types of the events (Main, Func_A, and Func_B) indicated by the type information 213. Because only a piece of information of a desired event can be collected by setting the type of the event, it is effective when there are many event types, the processing load of the system is desired to be decreased, and the like. It is assumed that these settings are performed mainly according to an input operation by a user. However, it is not limited thereto, and these settings can be performed automatically, for example, by the trace information management system 1 or other systems based on a predetermined condition. The setting unit 103 can be configured by using the input device 24, the CPU 21, the control program stored in the ROM 22, the RAM 23, an appropriate logic IC, or the like.

The generation unit 104 generates initial state information and state transition information based on the trace information 201, the index information 251, and time range information indicating the set time range. The initial state information is information indicating the states of the respective events at a start time point (140 in this example) in the time range. The state transition information is information indicating transition of the states of the events having occurred from the start time point to an end time point (190 in this example) in the time range. When the setting unit 103 sets the type, the generation unit 104 can generate the initial state information and the state transition information related only to the set type.

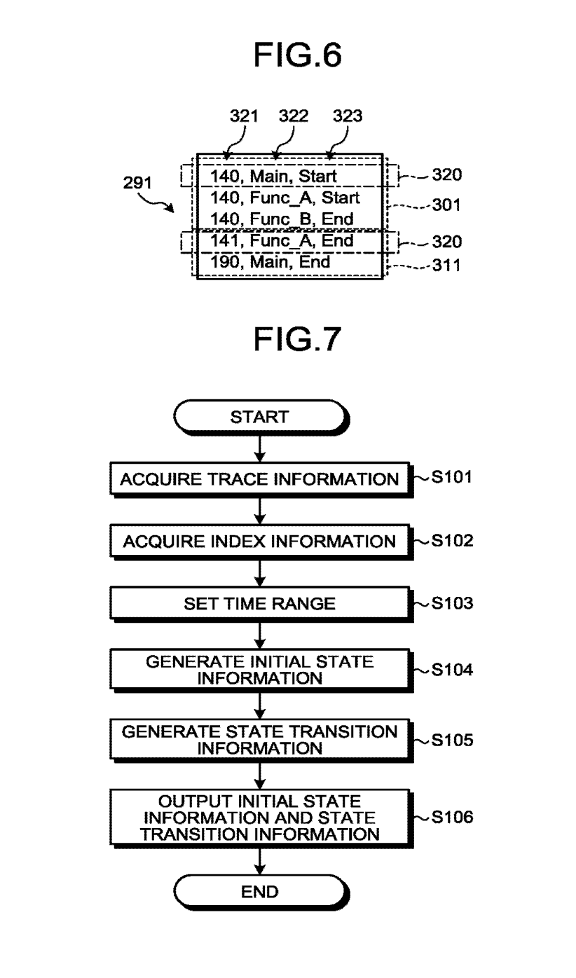

FIG. 6 is a diagram exemplifying initial state information 301 and state transition information 311 according to the first embodiment. The initial state information 301 and the state transition information 311 include time information 321, type information 322, and state information 323 as the fields, and are configured by one or more records 320 in which these fields are associated with each other.

The initial state information 301 indicates states (Start or End) of the respective events (Main, Func_A, and Func_B) at the start time point (140) in the set time range (140 to 190). Although the generation method of the initial state information 301 is not particularly to be limited, a state prior to and closest to the state at the start time point (140) is extracted from the index information 251, and a difference between the state extracted from the index information 251 and the actual state at the start time point is corrected based on the trace information 201, thereby enabling to generate the initial state information 301 without reading the trace information 201 from the beginning. Specifically, after the states of the respective events (Main: Start, Func_A: Start, and Func_B: End) corresponding to a right-before timing 265A (100), which is the index timing 265 earlier than the start time point (140) and closest to the start time point, are extracted from the index information 251, the initial state information 301 can be generated by updating the state extracted from the corresponding index information 251 based on the transition of the state (the transition indicated by records 210C and 210D in FIG. 4) that has occurred since the right-before timing 265A until the start time point, by referring to the trace information 201. The generation method of the initial state information 301 is described in detail later.

The state transition information 311 is information indicating transition of the states of the respective events that have occurred from the start time point (140) until the end time point (190) in the time range, and is information that can be extracted from the trace information 201. As illustrated in FIG. 4, the state transition information 311 according to this example is information indicated by the records 210A and 210B.

The initial state information 301 and the state transition information 311 generated in the manner described above are output to and used by other appropriate systems, for example, a GUI (Graphical User Interface) system that visualizes an execution status of a program, an analysis system that performs a dynamic analysis of the program performance, or the like as output information 291. It is desired that the initial state information 301 and the state transition information 311 have a common format, that is, common fields (the time information 321, the type information 322, and the state information 323 in this example) from a viewpoint of availability by other systems.

FIG. 7 is a flowchart illustrating an overall processing flow in the trace-information management system 1 according to the first embodiment. The trace-information acquisition unit 101 first acquires the trace information 201 (S101), and thereafter, the index-information acquisition unit 102 acquires the index information 251 (S102). The setting unit 103 then sets the time range according to the input operation or the like by a user (S103). Thereafter, the generation unit 104 generates the initial state information 301 and the state transition information 311 based on the trace information 201, the index information 251, and the time range (S104 and S105). Thereafter, the output information 291 including the generated initial state information 301 and the state transition information 311 is output to a predetermined system (S106).

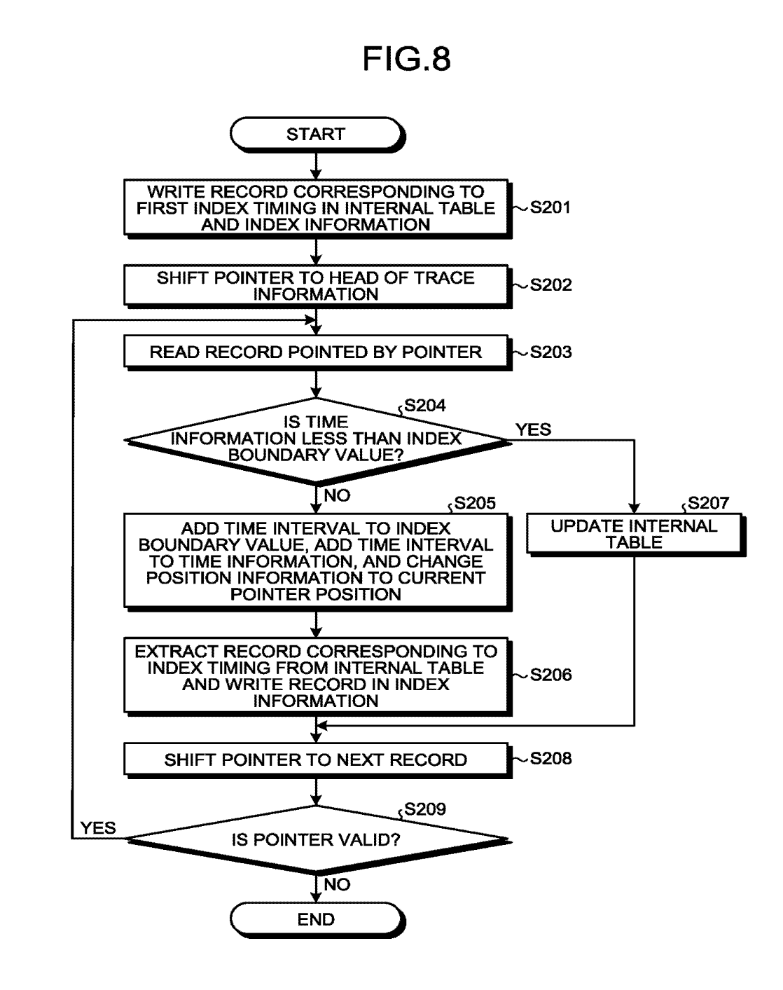

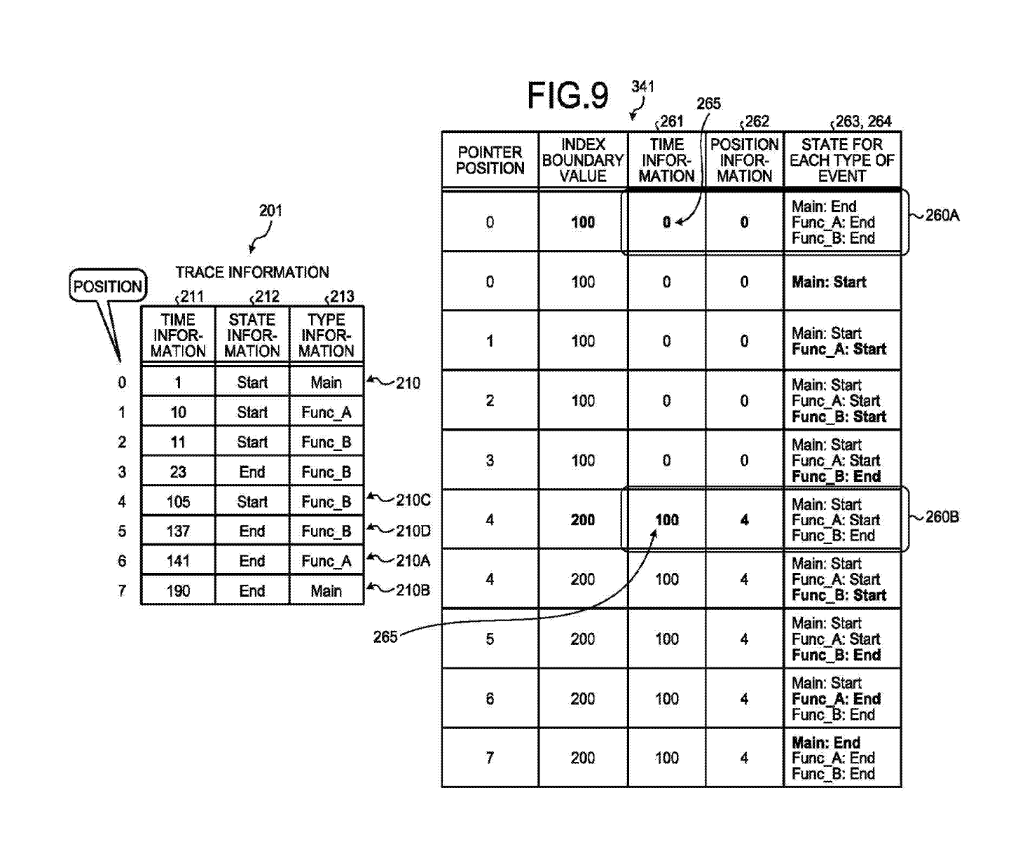

FIG. 8 is a flowchart exemplifying a processing flow at the time of acquiring the index information 251 from the trace information 201 according to the first embodiment. FIG. 9 is a diagram exemplifying an internal table 341 used at the time of acquiring the index information 251 from the trace information 201 according to the first embodiment. The internal table 341 is a table used for internal processing at the time of acquiring the index information 251. The index information 251 is updated by writing a part of data having been written in the internal table 341, in the index information 251.

First, the index-information acquisition unit 102 writes the record 260A corresponding to the index timing 265: 0 at the head in the internal table 341 and the index information 251 (S201). At this time, all the states of the respective events become End. Thereafter, the index-information acquisition unit 102 shifts a pointer to the head (a position 0) of the trace information 201 (S202). Thereafter, the index-information acquisition unit 102 reads the record 210 pointed by the pointer (S203).

Thereafter, the index-information acquisition unit 102 determines whether a value of the time information 211 included in the read record 210 is less than an index boundary value (S204). The index boundary value is a value of the index timing 265 (for example, 100) next to the index timing 265 (for example, 0) corresponding to the record already written in the index information 251 (for example, the record 260A). The index boundary value is updated in such a manner of 100, 200, 300, . . . with the progress of the pointer (the update of the index information 251).

If a value of the time information 211 included in the read record 210 is less than the index boundary value (YES at S204), the information in the internal table 341 (the state for each type of the event) is updated based on the state information 212 and the type information 213 included in the read record 210 (S207). In the example illustrated in FIG. 9, when the pointer position is in a range from 0 to 3, it is determined as YES at Step S204. Thereafter, the index-information acquisition unit 102 shifts the pointer to the next record (S208). Thereafter, the index-information acquisition unit 102 determines whether the pointer position after the shift is valid. If the pointer position is valid (YES at S209), the index-information acquisition unit 102 performs Step S203, or if the pointer position is not valid (NO at S209), the index-information acquisition unit 102 finishes a routine for acquiring the index information 251.

If the value of the time information 211 included in the read record 210 is not less than the index boundary value (NO at S204) (for example, the pointer position is 4 and the value of the time information 211 is 105), the index-information acquisition unit 102 adds a time interval (100) of the index timing 265 to the index boundary value, to update the internal table 341 by changing the position information 262 to the current pointer position (S205). Thereafter, the index-information acquisition unit 102 extracts the record 260B corresponding to the index timing 265 (100, 200, . . . ) (having a value of the time information 261 matching the value of the index timing 265) from the internal table 341 having been updated at Step S205, and writes the record 260B in the index information 251 (S206). Thereafter, the index-information acquisition unit 102 shifts the pointer to the next record (S208).

According to the index information 251 acquired by the process described above, the states of the respective events at the respective index timings 265 (the correspondence relation between the type and the state of the events) are recorded like a snapshot.

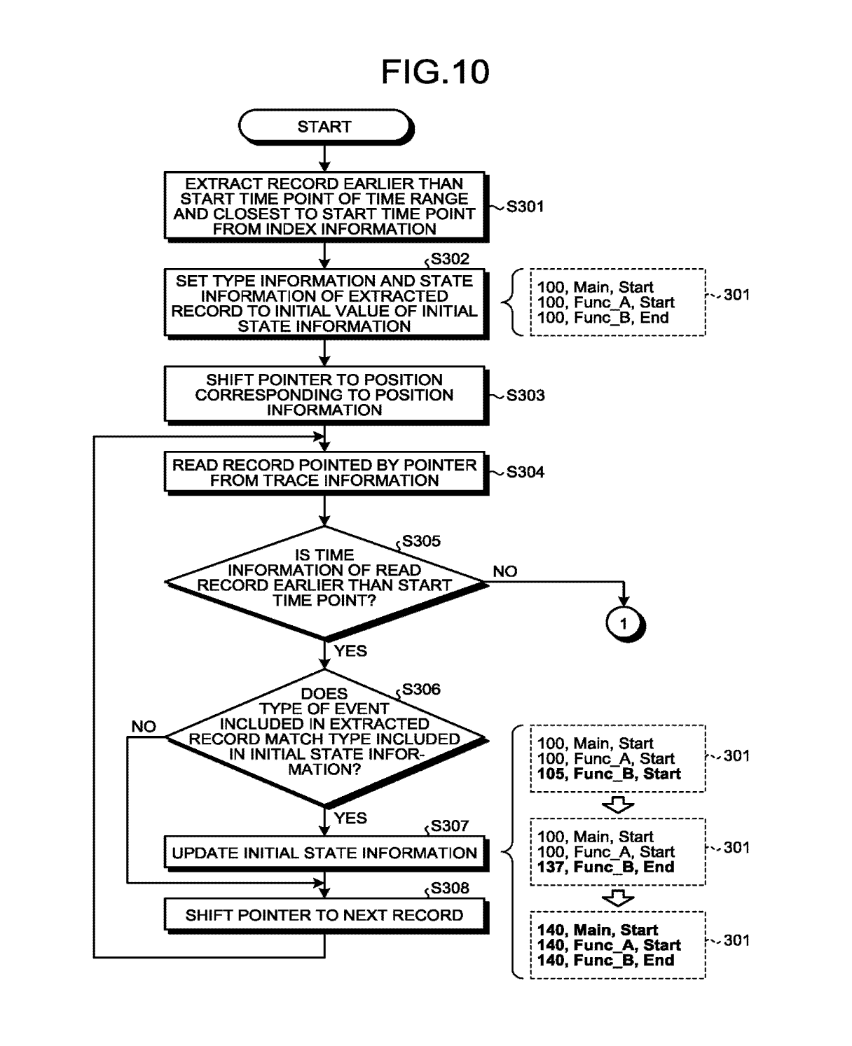

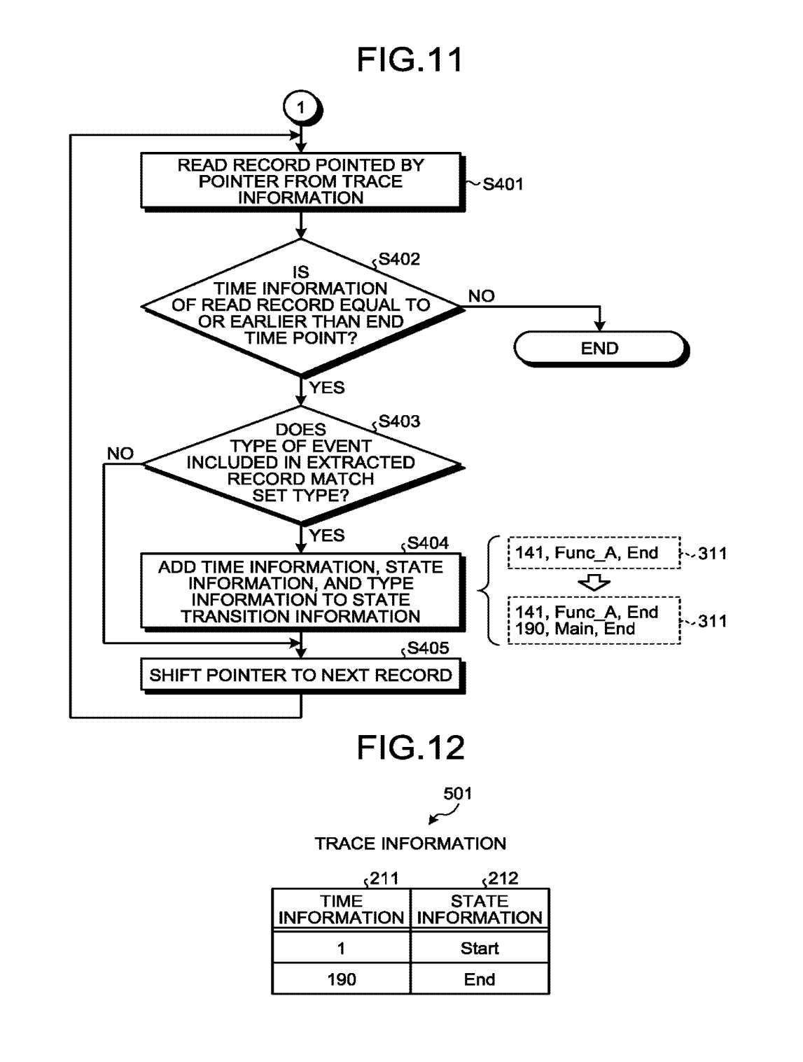

FIG. 10 is a flowchart illustrating a processing flow at the time of generating the initial state information 301 according to the first embodiment. FIG. 11 is a flowchart illustrating a processing flow at the time of generating the state transition information 311 according to the first embodiment. First, the generation unit 104 extracts a record 260 (the record 260B) earlier than the start time point (140) of the time range (140 to 190) and closest to the start time point from the index information 251 (S301). Thereafter, the generation unit 104 sets the type information 263 and the state information 264 corresponding to the type set by the setting unit 103 (if the type has not been set by the setting unit 103, all the pieces of type information 263 and state information 264), of the pieces of type information 263 and state information 264 included in the extracted record 260, to an initial value of the initial state information 301 (S302).

Thereafter, the generation unit 104 shifts the pointer to the position in the trace information 201 corresponding to the position information 262 (4 or 5) (S303), and reads the record 210 (the record 210C or 210D) pointed by the pointer from the trace information 201 (S304).

Subsequently, the generation unit 104 determines whether the value (105 or 137) of the time information 211 in the read record 210 is less than the start time point (140) (S305). If the value of the time information 211 is less than the start time point (YES at S305), the generation unit 104 determines whether the type indicated by the type information 213 included in the extracted record 210 (the record 210C or 210D) matches the type included in the current initial state information 301 (S306). If the type indicated by the type information 213 included in the extracted record 210 matches the type included in the current initial state information 301 (YES at S306), the generation unit 104 updates the initial state information 301 so as to match the state information 212 included in the extracted record 210 (S307). Thereafter, the generation unit 104 shifts the pointer to the next record (S308), and reads the record 210 pointed by the pointer again (S304). If the type indicated by the type information 213 included in the extracted record 210 does not match the type included in the current initial state information 301 (NO at S306), the generation unit 104 shifts the pointer to the next record without updating the initial state information 301 (S308).

If the value of the time information 211 in the record 210 read by the generation unit 104 is not less than the start time point (NO at S305), that is, if the value of the time information 211 becomes 141 (the position of the pointer is 6) in the first embodiment, a process of generating the state transition information 311 illustrated in FIG. 11 is performed.

When the process of generating the state transition information 311 illustrated in FIG. 11 is performed, the generation unit 104 reads the record 210 (the record 210A or 210B) pointed by the pointer (S401), and determines whether the value of the time information 211 in the read record 210 is equal to or less than the end time point (190) (S402). If the value of the time information 211 is not equal to or less than the end time point (190) (NO at S402), the routine for generating the state transition information 311 is finished. If the value of the time information 211 is equal to or less than the end time point (YES at S402), the generation unit 104 determines whether the type (Func_A or Main) indicated by the type information 213 included in the extracted record 210 (the record 210A or 210B) matches the type set by the setting unit 103 (if the type is not set by the setting unit 103, all the types) (S403). If the type indicated by the type information 213 included in the extracted record 210 matches the type set by the setting unit 103 (if the type is not set by the setting unit 103, all the types) (YES at S403), the generation unit 104 adds the time information 211, the state information 212, and the type information 213 included in the extracted record 210 to the state transition information 311 (S404). Thereafter, the generation unit 104 shifts the pointer to the next record (S405) and reads the record 210 pointed by the pointer again (S401). If the type indicated by the type information 213 included in the extracted record 210 does not match the type set by the setting unit 103 (if the type is not set by the setting unit 103, all the types) (NO at S403), the generation unit 104 shifts the pointer to the next record without adding new information to the state transition information 311 (S405).

By using the initial state information 301 and the state transition information 311 generated as described above, the state transition of the respective events generated within the arbitrarily set time range (140 to 190) can be ascertained appropriately. Further, according to the initial state information 301 of the first embodiment, because the states of the respective events at the start time point (140) in the time range can be ascertained, wasteful processes such as reading the trace information 201 from the beginning can be avoided. Consequently, various processes can be performed by efficiently using only a part of the trace information.

Each of the hardware configurations illustrated in FIGS. 1 and 2 is only an example, and the trace-information management system 1 can be realized by various hardware configurations. For example, the trace-information acquisition unit 101, the index-information acquisition unit 102, the setting unit 103, and the generation unit 104 can be realized by a single general-purpose computer, a dedicated device including an embedded processor, or the like.

A basic functional configuration of the trace-information management system 1 is illustrated in FIG. 3. However, the embodiment is not limited thereto. For example, a configuration in which an operation is performed in parallel while respective functional blocks cooperate with each other, a configuration in which one functional block is divided into a plurality of functional blocks, and a configuration in which these configurations are combined can be used.

A program realizing the function of the trace-information management system 1 is recorded in a computer-readable recording medium such as a CD-ROM, a flexible disk (FD), a CD-R, or a DVD in a file in an installable format or an executable format, and can be provided via a predetermined drive device or the like. The program can be provided by downloading from a predetermined storage device connected to a network to a predetermined computer, or can be incorporated in a ROM or the like beforehand and provided to a predetermined information processing device. The program can be configured by a plurality of modules that realize the functions of the trace-information acquisition unit 101, the index-information acquisition unit 102, the setting unit 103, and the generation unit 104 described above.

Variations of the configuration described above are illustrated below. FIG. 12 is a diagram exemplifying trace information 501 according to a second example of the first embodiment. The trace information 501 according to this example includes the time information 211 and the state information 212, but does not include the type information 213 included in the trace information 201 according to the first example illustrated in FIG. 4. When there is only one type of event, the data structure can be such as the trace information 501 according to the second example, thereby enabling to reduce the data amount and the processing load.

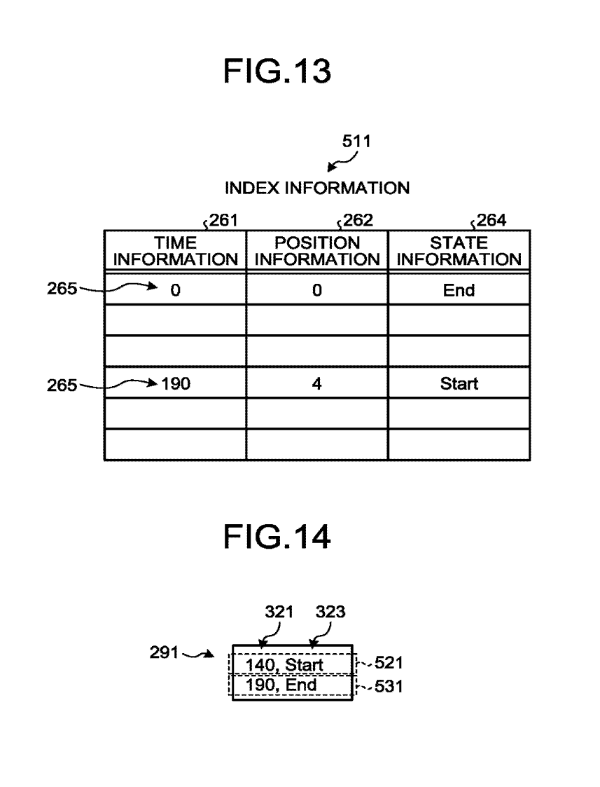

FIG. 13 is a diagram exemplifying index information 511 according to the second example of the first embodiment. The index information 511 according to this example includes the time information 261, the position information 262, and the state information 264, but does not include the type information 263 included in the index information 251 according to the first example illustrated in FIG. 5. As in the case of the trace information 501 according to the second example, when there is only one type of event, the data structure can be such as the index information 511 according to the second example, thereby enabling to reduce the data amount and the processing load.

FIG. 14 is a diagram exemplifying initial state information 521 and state transition information 531 according to the second example of the first embodiment. The initial state information 521 and the state transition information 531 according to this example include the time information 321 and the state information 323, but does not include the type information 322 included in the initial state information 301 and the state transition information 311 according to the first example illustrated in FIG. 6. As in the trace information 501 and the index information 511 according to the second example, when there is only one type of event, the data structure can be such as the initial state information 521 and the state transition information 531 according to the second example, thereby enabling to reduce the data amount and the processing load.

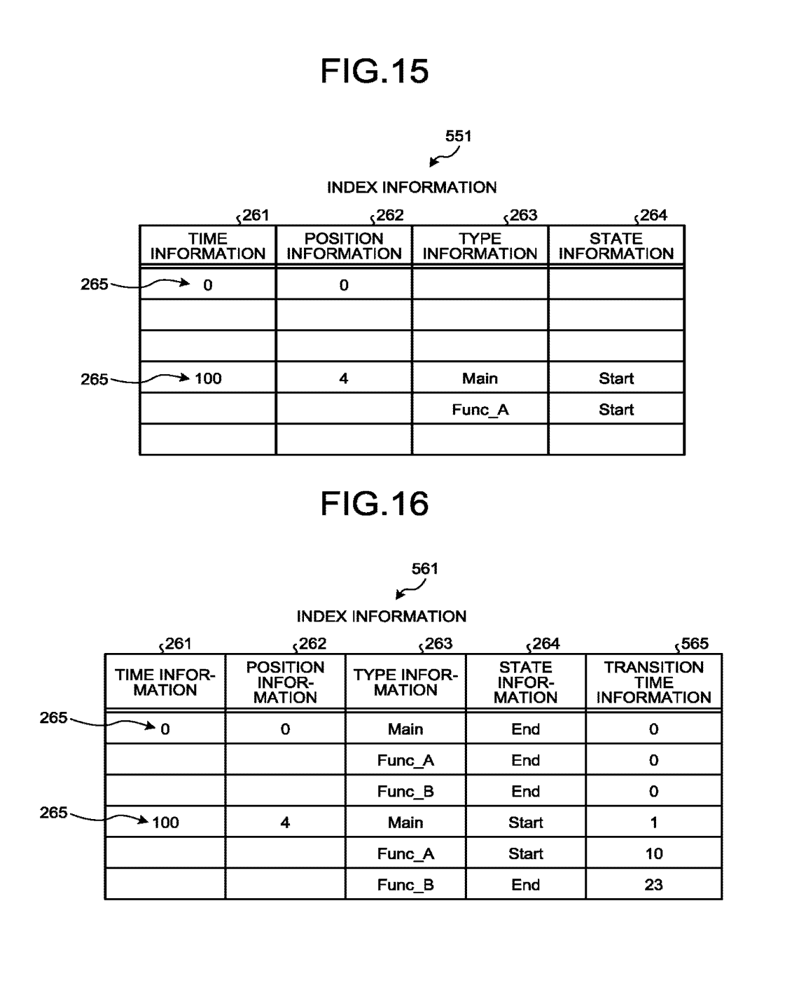

FIG. 15 is a diagram exemplifying index information 551 according to a third example of the first embodiment. The state information 264 in the index information 551 according to this example holds only Start indicating transition from the stopped state to the start state, but does not hold End indicating transition from the start state to the stopped state. Accordingly, the type information 263 in the index information 551 according to this example holds only an event having state transition of Start. There may be a case where it is sufficient if only the state transition of Start can be ascertained, depending on the feature of a program to be analyzed or a utilization mode of the index information 551. In such a case, the data structure can be such as the index information 551 according to the third example, thereby enabling to reduce the data amount and the processing load. On the contrary to this example, only the state transition of End can be recorded.

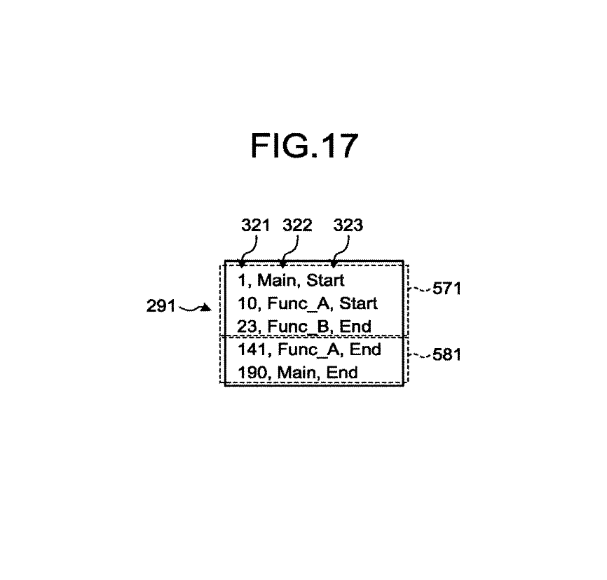

FIG. 16 is a diagram exemplifying index information 561 according to a fourth example of the first embodiment. FIG. 17 is a diagram exemplifying initial state information 571 and state transition information 581 according to the third example of the first embodiment. The initial state information 571 and the state transition information 581 according to the third example are generated by using the index information 561 according to the fourth example.

The index information 561 according to the fourth example includes transition time information 565 in addition to the data structure of the index information 251 according to the first example illustrated in FIG. 5. The transition time information 565 is information indicating a timing at which the state transition indicated by the state information 264 has occurred. The transition time information 565 can be extracted from the corresponding trace information (the trace information 201 according to the first example illustrated in FIG. 4 in the fourth example). The time information 321 in the initial state information 571 according to the third example is information in which the transition time information 565 in the index information 561 is written. The type information 322 and the state information 323 in the initial state information 571 according to the third example indicate states of the respective events at the start time point (140) of the set time range, as in the initial state information 301 according to the first example illustrated in FIG. 6. That is, according to the initial state information 571 of the third example, not only the states of the respective events at the start time point can be ascertained by the type information 322 and the state information 323, but also the timing at which the respective events have shifted to the state at the start time point can be ascertained by the time information 321.

As described above, the trace information, the index information, the initial state information, and the state transition information can have various data structures depending on a utilization status or the like.

According to the first embodiment described above, the state transition of the respective events generated within an arbitrarily set time range can be ascertained appropriately. Further, because the states of the respective events at the start time point in the time range can be ascertained based on the initial state information described above, wasteful processes such as reading the trace information having a large amount of data from the beginning can be avoided. Consequently, various processes such as visualization of an execution status of a program and dynamic analysis of the program performance can be performed by efficiently using only a part of the trace information.

### Second Embodiment

A second embodiment is described below. The generation unit 104 according to the second embodiment generates state transition information by aggregating at least one of plural numbers of state transition that have occurred within the set time range.

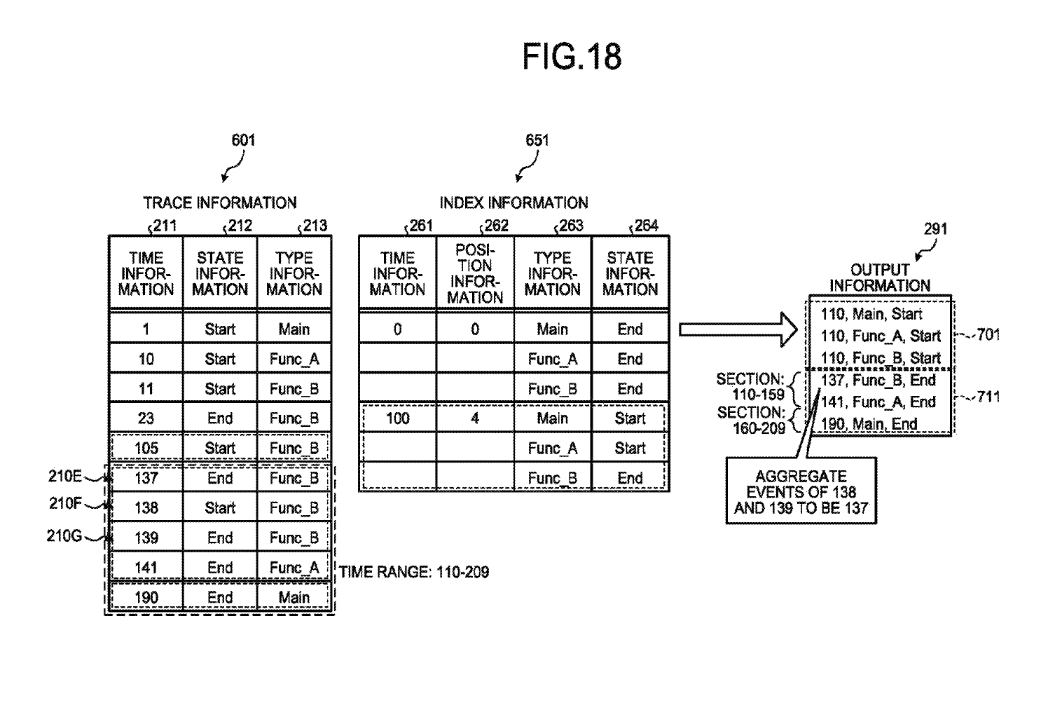

FIG. 18 is a diagram exemplifying a process at the time of generating state transition information 711 according to a first example of the second embodiment. In FIG. 18, trace information 601, index information 651, initial state information 701, and the state transition information 711 according to the second embodiment are illustrated. The time range according to the second embodiment is from 110 to 209.

The generation unit 104 according to the first example of the second embodiment divides the time range (110 to 209) into a first section (110 to 159) and a second section (160 to 209). When the state of the same event includes plural numbers of transition within the same section and the state of the first transition matches the state of the last transition, the generation unit 104 writes only the information of the first transition in the state transition information 711. In the first section (110 to 159) of the trace information 601 according to the second embodiment, the state of Func_B includes three times of transition at timings of 137, 138, and 139 of the time information 211, and the first transition state and the last transition state are End and match each other. In such a case, the generation unit 104 according to this example writes only the information related to the first transition (information included in a record 210E) in the state transition information 711, and does not write the information related to the transition of Func_B having occurred thereafter (information included in records 210F and 210G) in the state transition information 711. By performing such a process, when the same state transition of the same event is performed many times within the set time range, an amount of information of the state transition information 711 can be reduced without causing a substantial disadvantage. In this example, only the information related to the first transition is written in the state transition information 711. However, for example, only the information related to the last transition, information related to averaged transition, or the like can be written in the state transition information 711 depending on the usage of the extracted data. As described above, the information written in the state transition information 711 can be various pieces of information representing the transition of a plurality of records by specific transition.

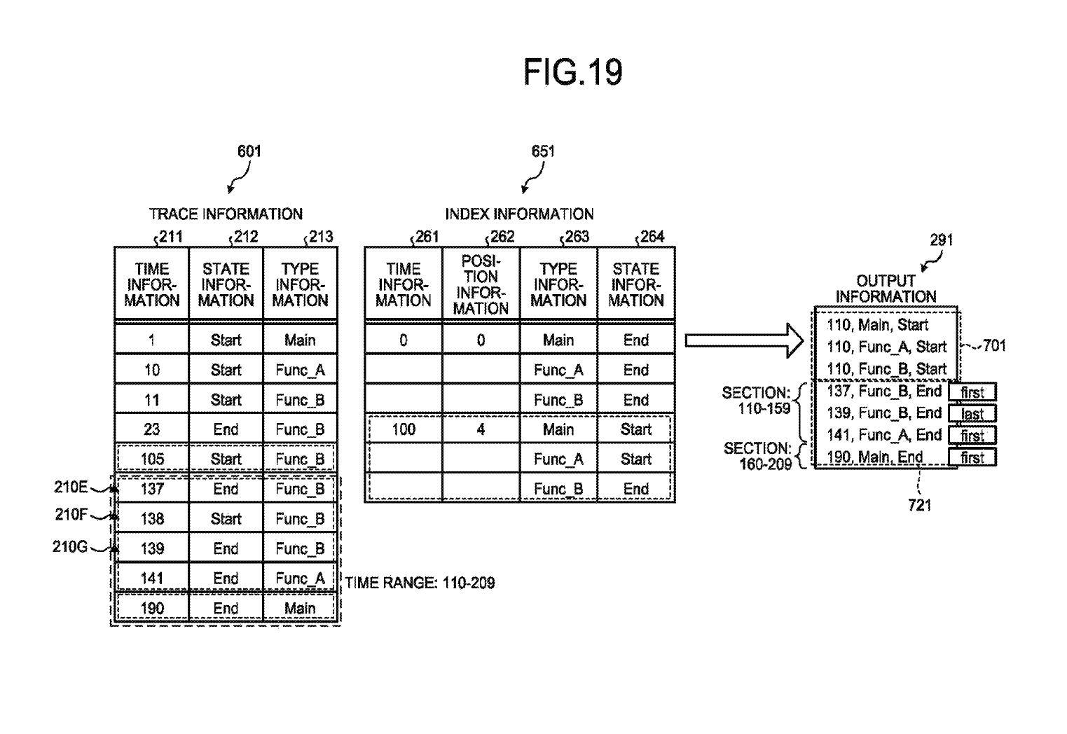

FIG. 19 is a diagram exemplifying a process at the time of generating state transition information 721 according to a second example of the second embodiment. The state transition information 721 according to this example is different from the state transition information 711 according to the first example illustrated in FIG. 18.

The generation unit 104 according to the second example of the second embodiment divides the time range (110 to 209) into the first section (110 to 159) and the second section (160 to 209). When the state of the same event includes plural numbers of transition within the same section, the generation unit 104 writes only information related to the first transition and information related to the last transition in the state transition information 721. In the first section (110 to 159) of the trace information 601 according to the second embodiment, the state of Func_B has shifted to End at a timing of 137 of the time information 211, has shifted to Start at a timing of 138 of the time information 211, and has shifted to End at a timing of 139 of the time information 211. In such a case, the generation unit 104 according to this example writes only the information related to the first transition (information included in the record 210E) and the information related to the last transition (information included in the record 210G) in the state transition information 721, but does not write the information related to the transition of Func_B having occurred therebetween (information included in the record 210F) in the state transition information 721. By performing such a process, when the same state transition of the same event is performed many times within the set time range, an amount of information of the state transition information 721 can be reduced without causing a substantial disadvantage.

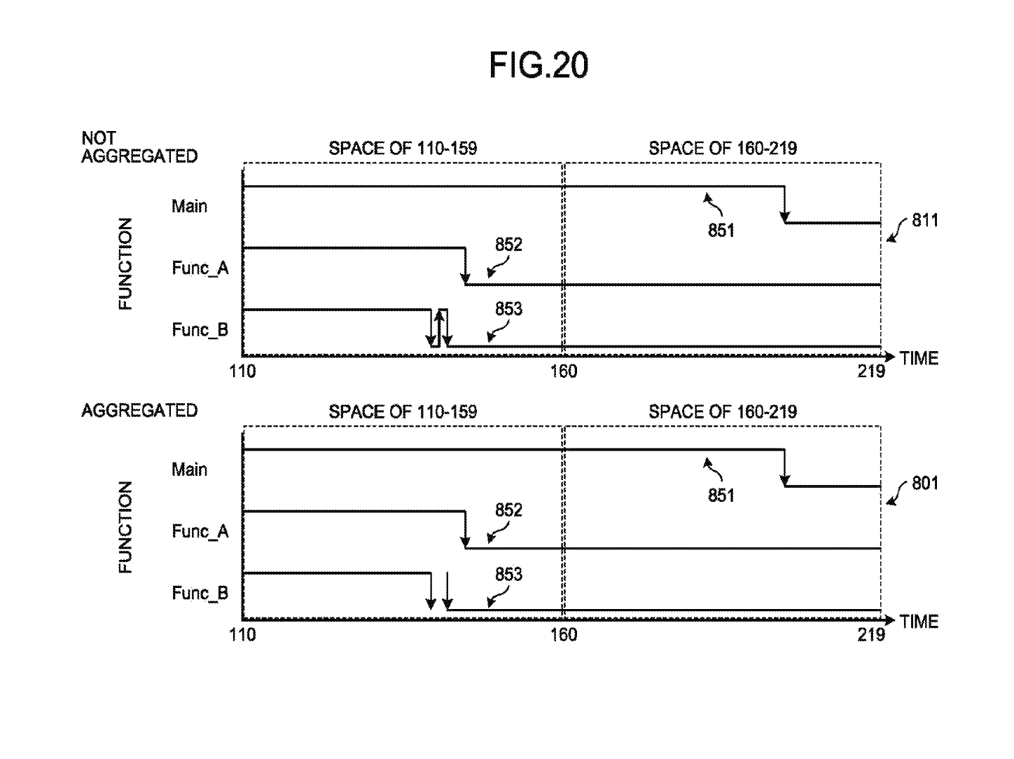

FIG. 20 is a diagram exemplifying a display image that visualizes state transition of an event having occurred within a time range, by using the initial state information 701 and the state transition information 721 according to the second example of the second embodiment. In a lower part of FIG. 20, a display image 801 generated by using the initial state information 701 and the state transition information 721 according to the second example of the second embodiment is illustrated. In an upper part thereof, a display image 811 according to a comparative example generated by using normal initial state information and state transition information is illustrated. That is, in FIG. 20, the display image 801 using the state transition information 721 aggregated as described above is compared with the display image 811 using the state transition information that is not aggregated.

In the display images 801 and 811, a transition object 851 indicating a state transition of Main, a transition object 852 indicating a state transition of Func_A, and a transition object 853 indicating a state transition of Func_B are drawn.

As described above, the state transition information 721 according to the second example of the second embodiment illustrated in FIG. 19 does not include the information included in the record 210F corresponding to the timing 138 of the time information 211. Therefore, an object of an up arrow corresponding to the state transition information (Func_B: Start) included in the record 210F is not illustrated in the transition object 853 corresponding to Func_B in the display image 801 generated by using the state transition information 721. In this example, the object corresponding to the record 210F is not always necessary in a broader sense. As described above, by deleting the information (an object) that can be said unnecessary in a broader sense, reduction of the amount of information and the processing load can be realized and it can be avoided that a display image is complicated.

### Third Embodiment

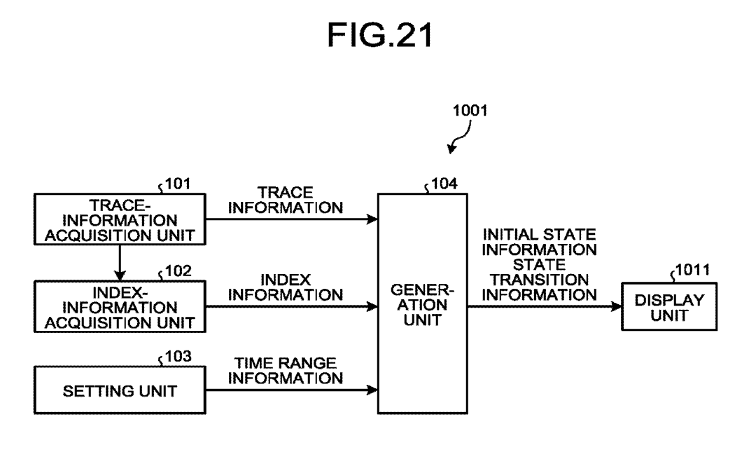

FIG. 21 is a diagram exemplifying a functional configuration of a visualization system 1001 according to a third embodiment. The visualization system 1001 is a system for visualizing time-series data. The visualization system 1001 includes a display unit 1011. The time series data is data including state-transition event information in which a time point and state transition of an event are linked with each other. The trace information 201, the trace information 501, and the trace information 601 are examples of the time-series data.

The display unit 1011 is a functional unit that visualizes time-series data based on the output information 291 (the initial state information 301, 521, 571, and 701 and the state transition information 311, 531, 581, 711, and 721) generated by the generation unit 104 of the trace-information management system 1 according to the first embodiment or the second embodiment. The display unit 1011 can be configured by using, for example, the output device 25, the control program stored in the CPU 21 or the ROM 22, the RAM 23, or an appropriate logic IC.

The display unit 1011 divides the time included in the time-series data in specific time periods, extracts the first state-transition event information and the last state-transition event information included in each of the specific time periods, and visualizes the state transition in each of the specific time periods based on the extracted state-transition event information.

The display unit 1011 can decide the specific time period based on a visualized time range and a display resolution. For example, when the visualized time range is 10,000 seconds, which is from 100 seconds to 10,100 seconds, and the display resolution on an axis on a chart in which time points are mapped is 100, the specific time period can be decided as 10,000/100=100. The display resolution is, for example, the number of pixels on a display or a unit (for example, every ten pixels is regarded as one unit) decided by a display apparatus.

When only one event exists during a specific time period, the display unit 1011 can extract only the one event. Further, when the display unit 1011 extracts the first state-transition event information and the last state-transition event information included in each specific time period, a state-transition event number included in the specific time period can be extracted. The state-transition event number is the number of events having the state thereof being transitioned. Furthermore, the display unit 1011 can visualize the state-transition event number in each specific time period based on an extracted state-transition event number. The display unit 1011 can add information related to the state-transition event number to the extracted first state-transition event information and the extracted last state-transition event information.

According to the visualization system 1011 of the third embodiment, visualization of state transition of time-series data can be realized with high quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A trace-information management system comprising a processor configured to:
acquire trace information indicating transition of a state of an event that occurs in chronological order;
acquire index information indicating a correspondence relation between the event and the state at index timings set so as to have a predetermined time interval therebetween on a time axis of the trace information;
set a start time point; and
generate initial state information indicating the state at the start time point, based on the trace information and the index information.

2. The system according to claim 1, wherein the processor is configured to set a time range including the start time point and an end time point, and generate state transition information indicating the transition that has occurred from the start time point to the end time point based on the trace information.

3. The system according to claim 2, wherein the processor is configured to generate the initial state information by extracting the state corresponding to a right-before timing that is the index timing that is earlier than the start time point and closest to the start time point from the index information, and by updating the extracted state based on the transition that has occurred from the right-before timing to the start time point.

4. The system according to claim 2, wherein the trace information, the index information, the initial state information, and the state transition information indicate the state for each type of the event.

5. The system according to claim 1, wherein the state is any of a start state or an end state.

6. The system according to claim 2, wherein the initial state information and the state transition information are generated in a common format.

7. The system according to claim 4, wherein the processor is configured to set the type of the event, and generate the initial state information and the state transition information so that only the state corresponding to the set type is included.

8. The system according to claim 2, wherein the processor is configured to generate the state transition information by aggregating at least one of plural numbers of the transition that have occurred from the start time point to the end time point.

9. The system according to claim 8, wherein the processor is configured to divide the time range into a plurality of sections, and when the state of the same event includes plural numbers of transition within the same section and the state by first one of the transition matches the state by last one of the transition, write only information of the first transition in the state transition information.

10. The system according to claim 8, wherein the processor is configured to divide the time range into a plurality of sections, and when the state of the same event includes plural numbers of transition within the same section, write only the information related to first one of the transition and the information related to last one of the transition in the state transition information.

11. The system according to claim 2, wherein the state transition information includes information indicating a timing at which the transition has occurred within the time range.

12. The trace-information management system comprising:
an information processing terminal; and
a server connected to the information processing terminal via a network, wherein
the server includes a processor configured to:
acquire trace information indicating transition of a state of an event that occurs in chronological order;
acquire index information indicating a correspondence relation between the event and the state at index timings set so as to have a predetermined time interval therebetween on a time axis of the trace information;
set a start time point; and
generate initial state information indicating the state at the start time point, based on the trace information and the index information.

13. A trace-information management method comprising:
acquiring trace information indicating transition of a state of an event that occurs in chronological order;
acquiring index information indicating a correspondence relation between the event and the state at index timings set so as to have a predetermined time interval therebetween on a time axis of the trace information;
setting a start time point; and
generating initial state information indicating the state at the start time point, based on the trace information and the index information.

14. A trace-information management program product having a non-transitory computer readable medium including a program, wherein the program, when executed by a computer, causes the computer to execute:
acquiring trace information indicating transition of a state of an event that occurs in chronological order;
acquiring index information indicating a correspondence relation between the event and the state at index timings set so as to have a predetermined time interval therebetween on a time axis of the trace information;
setting a start time point; and
generating initial state information indicating the state at the start time point, based on the trace information and the index information.
